(19) United States
(12) Patent Application Publication
(10) Pub. No.: US 2015/0328779 A1
(43) Pub. Date: Nov. 19, 2015

(54) SUCTION CUP

(71) Applicant: SHORT BROTHERS PLC, Antrim (GB)

(72) Inventors: Lynsey BOWMAN, Holywood (IE); Andrew JESS, Delta (CA); Paul FRAZER, Holywood (IE)

(21) Appl. No.: 14/652,938

(22) PCT Filed: Dec. 21, 2012
(86) PCT No.: PCT/EP2012/076795

§ 371 Date: Jun. 17, 2015

(51) Int. Cl. B25J 15/06

(52) U.S. Cl. CPC B25J 15/0683

(57) ABSTRACT

A suction cup includes a body with a central axis, a first end having an opening, and a second end adapted to be connected to a vacuum source, thereby drawing a vacuum through the opening. A lip is provided on the body, which defines a periphery around the opening. An obstruction element with an exterior surface extends across at last part of the opening. The obstruction element defines a plurality of holes therethrough and presents an exterior surface that is substantially flush with the lip. The obstruction element discourages distortion of a fabric drawn to the suction cup, when the vacuum is applied by the vacuum source, to a degree that exceeds a predetermined, acceptable threshold.

### FIELD OF THE INVENTION

The present invention concerns the construction and operation of a suction cup that is designed to lift, manipulate, and transfer fabric. More specifically, the suction cup of the present invention is designed to lift, manipulate, and transfer fabrics used to create composite materials, such as those employed for the construction of aircraft.

### DESCRIPTION OF THE RELATED ART

The prior art includes examples of several devices that may be employed to handle porous and non-porous flexible materials. This includes woven and non-woven fabrics, among other materials.

Some of these devices incorporate suction cups.

U.S. Pat. No. 8,092,369 (hereinafter “the '369 patent”) describes an organ manipulator using suction. Specifically, at FIGS. 3 and 4, the '369 patent describes an embodiment of a suction cup for retracting tissue, such as a heart, and holding the tissue in the retracted position. (The '369 patent at col. 8, lines 13-17.) The suction cup has a flexible silicone rubber shell 31 with a cylindrical attachment portion 32 for connection to a suction line 5. (The '369 patent at col. 10, lines 41-44.) The shell 31 encases an absorbent material 33 that is able to absorb blood and other fluids to improve the grip of the suction cup on the tissue. (The '369 patent at col. 10, lines 48-51.) A non-abrasive mesh 34 covers the absorbent material. (The '269 patent at col. 10, lines 52-54.)

U.S. Pat. No. 7,766,596 (hereinafter “the '596 patent”) describes an attachment for a telescoping material handler for manipulating a load (such as wallboard) with five degrees of freedom. The '596 patent describes the use of a gripping system 13 that includes vacuum cups 28 and a vacuum pump 26. (The '596 patent at col. 4, lines 58-61.) The gripping system 13 may be employed to lift and handle wall cladding of up to 350 kg (889 lb). (The '596 patent at the Abstract.)

U.S. Pat. No. 6,841,726 (hereinafter “the '726 patent”) describes a page turning device that includes a suction cup 94 connected to a vacuum pump 56. (The '726 patent at col. 5, lines 11-14.) The suction cup 94 is used to automatically turn the pages in a book, for example. (The '726 patent at col. 3, lines 51-53.)

U.S. Pat. No. 5,009,409 (hereinafter “the '409 patent”) describes a method and apparatus for manipulating a porous fabric, such as a fiberglass cloth. (The '409 patent at col. 1, lines 9-14.) The device relies on air flow through holes 54 in a flow locator 10 to pick up a batt of the fibrous material. (The '409 patent at col. 5, lines 45-49.)

U.S. Pat. No. 4,968,019 (hereinafter “the '019 patent”) describes a sheet feed mechanism for a copy machine that relics on a series of vacuum-driven suction cups to feed the sheets through the copy machine.

As should be apparent from the identification of the devices in the prior art, there remains a need for a device that handles fabric materials, such as fabrics used in the manufacture of composite components, without crimping, folding, stretching, or otherwise changing the shape of the fabric material as it is being handled.

### SUMMARY OF THE INVENTION

The present invention addresses one or more deficiencies associated with the prior art.

Specifically, the present invention provides a suction cup that includes a body defining a central axis. The body has a first end with an opening and a second end that is adapted to be connected to a vacuum source, thereby drawing a vacuum through the opening. A lip is provided on the body, defining a periphery around the opening. An obstruction element with an exterior surface extends across at least part of the opening. The obstruction element defines a plurality of holes therethrough. The obstruction element has an exterior surface that is substantially flush with the lip. The obstruction element discourages distortion of a fabric drawn to the suction cup, when the vacuum is applied by the vacuum source, to a degree that exceeds a predetermined, acceptable threshold.

In a further contemplated embodiment, the present invention provides for a suction cup where the body further includes a seal extending outwardly from the first end adjacent to the lip. The seal defines the opening.

In one contemplated embodiment, the obstruction element extends across at least a portion of the opening defined by the seal.

In another contemplated embodiment, the obstruction element comprises a wire mesh.

In still another contemplated embodiment, the obstruction element may be made from a metal, a metal alloy, plastic, a thermoplastic material, rubber, an elastomeric material, polyvinyl chloride, polytetrafluoroethylene, a composite material, and/or a ceramic.

It is contemplated that the seal may be made from a flexible material. In an alternative embodiment, the seal may be made from plastic, a thermoplastic material, rubber, and/or an elastomeric material.

The body of the suction cup may be made from metal, a metal alloy, plastic, a thermoplastic material, rubber, an elastomeric material, polyvinyl chloride, polytetrafluoroethylene, a composite material, and/or a ceramic.

It is contemplated, in at least one embodiment, that the exterior surface of the obstruction element may be disposed interiorly to the lip. In an alternative arrangement, the exterior surface of the obstruction element may be flush with the lip.

With respect to the holes in the obstruction element, it is contemplated that the holes may be arranged in a predetermined pattern. For example, the holes may be defined by wires forming the wire mesh.

The suction cup is contemplated to operate so that the predetermined, acceptable threshold for distortion of the fabric is less than a permanent distortion of the fabric. Non-permanent distortions of the fabric include, but are not limited to those distortions that are self-correcting and/or those that may be smoothed out by a device or person after the fabric has been released from the suction cup.

It is contemplated that the suction cup of the present invention will cooperate with woven fabric and also with non-woven fabric. The fabric may be a composite material such as carbon fiber and/or an aramid compound. The fabric may or may not incorporate a resin material.

It is contemplated that the vacuum source may generate suction via a Coanda gripper.

Still further features of the present invention should be appreciated from the drawings appended hereto and from the discussion herein.

### BRIEF DESCRIPTION OF THE DRAWINGS

The present invention will now be described in connection with the drawings appended hereto, in which:

FIG. 1 is a cross-sectional side view of a suction cup that assists with a description of one problem identified with respect to the use of suction cups with fabric;

FIG. 2 is a cross-sectional side view of a first embodiment of a section cup according to the present invention;

FIG. 3 is a perspective illustration of one contemplated construction for the suction cup illustrated in FIG. 2;

FIG. 4 is a cross-sectional side view of a second embodiment of a suction cup according to the present invention;

FIG. 5 is a perspective illustration of one contemplated construction for a portion of the second embodiment of the suction cup illustrated in FIG. 4;

FIG. 6 is a cross-sectional side view of a third embodiment of a suction cup of the present invention; and

FIG. 7 is a cross-sectional side view of a fourth embodiment of a suction cup of the present invention.

### DETAILED DESCRIPTION OF EMBODIMENT(S) OF THE INVENTION

The present invention will now be described in connection with one or more embodiments. Discussion of any one particular embodiment is intended to be illustrative of the breadth and scope of the invention. In other words, while attention is focused on specific embodiments, those embodiments are not intended to be limiting of the scope of the present invention. To the contrary, after appreciating the discussion and drawings presented herein, those skilled in the art will readily appreciate one or more variations and equivalents of the embodiments described and illustrated. Those variations and equivalents are intended to be encompassed by the present invention as though they were described herein.

The modern manufacture of aircraft has recently departed from traditional reliance upon aluminum and aluminum alloys for the external components of the aircraft and moved to a greater reliance on composite materials. As a general rule, composite materials are stronger and lighter than their metallic counterparts and, at least for this reason, present engineering and design advantages over metals and their alloys.

Manufacture of components from composite materials, however, is not without its engineering challenges.

As should be apparent to those skilled in the art, and by way of background to the discussion that follows, the term “composite material” encompasses a broad category of different substances. In the context of aircraft manufacture, composite materials are understood to refer to fabrics made from carbon fibers and resins. While the present invention encompasses carbon fiber fabrics, the present invention is not intended to be limited thereto. Other fabrics used in the manufacture of composite components are also intended to be encompassed by the present invention. For example, the present invention includes, but is not limited to, materials incorporating aramid fibers, ceramics, glass, and related compounds, either now known or developed in the future. Moreover, fabrics that combine different compounds and materials together also are intended to be encompassed by the present invention.

As a general rule, fabrics fall into one of two categories. The first category is woven fabrics. Woven fabrics encompass those that are made from threads of composite materials. Woven fabrics have a weft and weave, as should be apparent to those skilled in the art. These materials are similar to cloth made from other fibrous materials, such as cotton. The second category is non-woven fabrics. Non-woven fabrics encompass those that are not made from threads woven together. Typically, non-woven fabrics combine a plurality of fibers that are randomly intertwined to form a batt or, alternatively, aligned in a particular direction. These materials are sometimes known as having uni-directional or uni-axial fibers.

As should be apparent to those skilled in the art, when constructing an aircraft component, after multiple layers of fabric are layered onto one another in a predetermined orientation, a resin or other type of matrix material is used to bind the fabric layers to one another. To accomplish this, the fabric may be pre-impregnated with resin. Such fabrics are often referred to as “pre-preg” fabrics. Alternatively, the fabric may be a “dry” fabric, meaning that the fabric is not pre-impregnated with resin.

In either case, it is generally recognized that a resin will be introduced into the fabric and cured, typically using pressure and heat, to create the composite material component. Once cured into a hardened component, the hardened component may be further machined to fabricate the aircraft part.

One process employed for manufacturing and curing a composite fabric structure is known to those skilled in the art as “Resin Transfer Infusion” or “RTI.” Other processes also are known in the art, and the present invention is not intended to be limited to RTI.

As also should be apparent to those skilled in the art, regardless of the type of fabric employed for the construction of an aircraft component (i.e., a prepreg or a dry fabric), construction techniques using those fabrics tend to fall within two general categories. A first approach to the manufacture of aircraft parts relies on the repetitive application of layers of fabric strips, including what is commonly referred to as “tape” or “tow.” In this method of manufacture, the strips are applied to the surface of a mold, following a predetermined pattern. In a second approach to the manufacture of aircraft components, sheets of fabric, cut into predetermined shapes, are laid over one another in a predetermined pattern and arrangement. In either technique, the orientations of the fibers in the layers typically are altered from layer to layer. With each layer having a slightly different orientation, the strength of the aircraft component is maximized in many directions.

With respect to the manufacturing method that relies on the use of fabric strips, the strips are usually dispensed from a roll. In particular, as the roll of strips passes over the surface of the mold, a single layer of the fabric strips are dispensed onto the mold parallel lines. The orientation of the roll may be altered for each successive application of the strips to vary the directional orientation of the composite fibers.

The second manufacturing method relics on human manipulation of the fabric. Specifically, the individual pieces of material are first shaped by means of a cutting machine or other method and then positioned on the mold in the correct orientation. It is, of course, possible to employ one or more mechanical devices to position pieces of pre-cut fabric in a suitable orientation for formation of the aircraft component. It is with this second manufacturing method, in particular an automated process (or at least partially automated), that the present invention concerns itself.

When mechanical devices pickup and carry a piece of fabric to lay the fabric on a mold in a predetermined orientation, it is preferred for the fabric to be deposited on the mold such that the fabric is positioned properly and such that the fabric is not deformed, folded, or otherwise distorted. As should be apparent, when the fabric is deposited such that the fabric is in the correct orientation and without distortions, the layers of fabric will properly form the final composite structure that may be employed on an aircraft.

The present invention provides a suction cup that is employed to transfer fabric from one location to another via mechanical means, such as with one or more robots or other transfer devices. While a plurality of suction cups are contemplated to be used, in combination to transfer the fabric from one location to another, the present invention is directed to the construction of a single suction cup, as detailed in the paragraphs that follow.

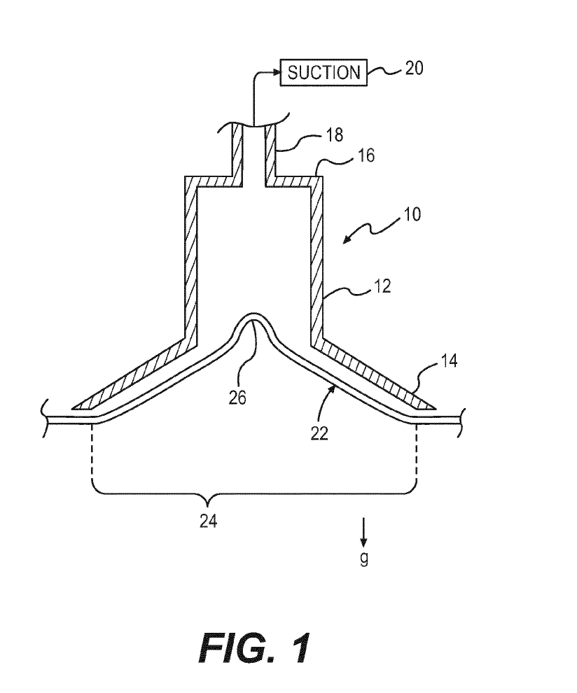

Reference is first made to FIG. 1, which illustrates a problem underlying the solution that encompasses the present invention. FIG. 1 depicts a suction cup 10 with a body 12. The body 12 has a generally cylindrical shape. The suction cup 10 also includes a flanged, annular section 14 that extends from the body 12. The flanged, annular section 14 acts as a seal between the suction cup 10 and the material that is lifted thereby. As a result, the flanged annular section 14 also is referred to herein as the seal 14. The top end 16 of the suction cup 10 includes a connector 18 that permits the suction cup 10 to be connected to a suction source 20 (also referred to as a vacuum source 20).

While the manner in which the suction is generated is not a focus of the present invention, it is noted that the suction may be generated by a device incorporating a Coanda gripper. A Coanda gripper uses a stream (or jet) of a gas, such as air, to generate suction using the Coanda effect. In brief, the Coanda effect (named after its discoverer, Henri Coanda) is the tendency of a fluid jet to attach itself to a nearby surface. The operation of a Coanda gripper device is known to those skilled in the art and, therefore, is not described in detail herein. Moreover, as noted, the device that generates the suction (or vacuum) is not critical to the present invention.

There are a number of variables that are anticipated to underlie the amount of suction that needs to be applied to the fabric 22. The weight of the fabric is one factor. The second factor is the size of the fabric 22. The third factor is its shape. The fourth factor is the stiffness of the fabric 22, and the fifth factor is the porosity of the fabric 22. Each factor is a variable that is taken into account when selecting an appropriate magnitude for the suction applied thereto. As should be apparent to those skilled in the art, there are further variables that may be taken into account. The listing of weight, size, shape, porosity, and stiffness of the fabric 22 is considered to be exemplary of the types of variables taken into account and is not considered to be limiting of the present invention.

It is noted that the suction cup 10 is anticipated to lift the fabric 22 in a direction parallel to, but against, the force of gravity, which is indicated by the reference “g” in FIG. 1. As should be apparent, the suction cup 10 should not be understood as being limited to lifting the fabric 22 only in a direction that is parallel to the force of gravity g. The suction cup 10 may lift the fabric 22 at an angle to the force of gravity g without departing from the scope of the present invention.

While developing the suction cup 10 of the present invention, the inventors discovered one problem associated with the use of a suction cup 10. Specifically, it was discovered that the fabric 22, which is flexible, has a tendency to be drawn toward the end 16 of the body 12 from the seal 14. Depending upon the magnitude of the suction applied by the vacuum source 20, the fabric 22 may be drawn partially or completely into the body 12. This creates a distortion region 24 where the fabric 22 has a tendency to form a conically shaped protrusion 26 or bump 26.

When the suction cup 10 is employed together with a plurality of suction cups 10 in an array, as is contemplated to be required to lift a sheet of the fabric 22, each of the suction cups 10 will individually generate conical protrusions 26. As a result, the fabric 22, once deposited onto a suitable mold, potentially may include a plurality of bumps 26.

As should be apparent to those skilled in the art, it is undesirable for the fabric 22 to include any deformations or bumps 26 when placed onto a mold. To properly form the composite aircraft component, it is desirable for each layer of fabric 22 to lie completely flat against the mold or the underlying layer of fabric 22 previously deposited on the mold. Therefore, it is desirable for any apparatus that manipulates a fabric 22 to do so without distortion (or at least with minimal distortion) of the fabric 22.

As should be apparent to those skilled in the art, fabrics 22 are somewhat stiff. As a result of this stiffness, if the fabric 22 is distorted, it is not anticipated that the fabric 22 possesses sufficient resiliency to return to a flat state after being released from the suction cup 10 during deposition onto the mold or the layer of fabric 22 previously deposited on the mold. Accordingly, a construction for the suction cup 10 preferably includes one or more features that eliminate (or at least minimize) distortion of the fabric 22 prior to deposition.

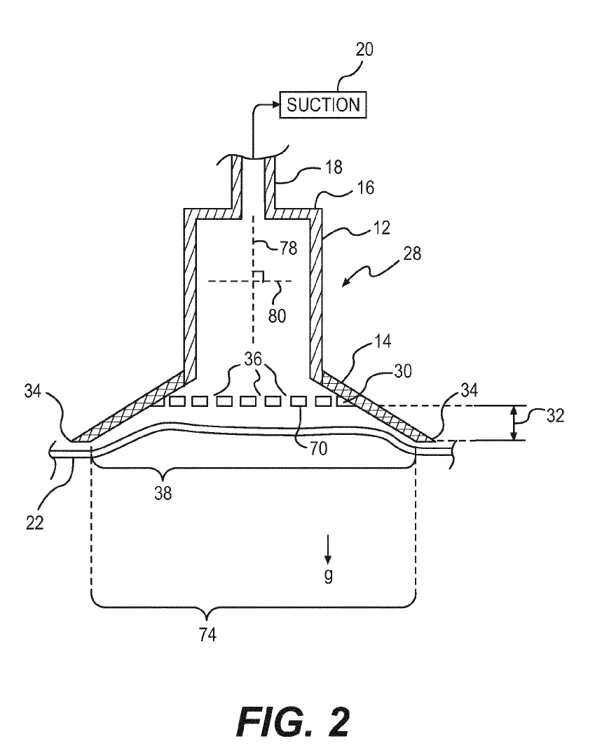

FIG. 2 is a cross-sectional side view of a first embodiment of a suction cup 28 according to the present invention. The suction cup 28 has a body 12 and an annular section 14 (also referred to as a flanged section 14 herein). The suction cup 28 includes an obstruction element or grate 30 disposed in the annular section 14. The obstruction element 30 permits air to be drawn through the suction cup 28, but prevents the fabric 22 from being drawn into the body 12 of the suction cup 28.

As should be apparent from the drawings, and as should be apparent from the discussion herein, the obstruction element 30 may have any suitable construction that discourages the ingestion by the suction cup 28 of the fabric 22 beyond a point that inhibits a return of the fabric 22 to a flat or substantially flat condition. It is one aspect of the obstruction element 30 to prevent distortion of the fabric 22 beyond a limit where any distortion of the fabric 22 is not correctible. In one instance, it is understood that if the suction cup 28 draws the fabric 22 only a small distance into the body 12, the fabric 22 has a sufficient degree of resilience to return to a flat or substantially flat condition after being deposited onto the mold. If the fabric 22 is drawn into the body 12 a greater distance, it is contemplated that the distortions 26 may be smoothed out via a suitable automatic roller or via manipulation by human hands. In either instance, the obstruction element 30 discourages the formation of distortions 26 in the fabric 22 that exceed the ability of the fabric 22 to be returned to a flat or a substantially flat condition.

As should be apparent to those skilled in the art, the obstruction element 30 may have any suitable construction without departing from the scope of the present invention. For example, the obstruction element 30 may be a grate. Alternatively, the obstruction element 30 may be a perforated plate. Still further, the obstruction element 30 may be a rigid or semi-rigid fabric or mesh that permits gas, such as air, to pass easily therethrough. The number of possible variations for the obstruction element 30 are too numerous to list here. It is noted that the obstruction element 30 is not limited to the specific examples that are provided above.

As illustrated in FIG. 2, the obstruction element 30 is disposed interiorly to the seal 14 by a distance 32 from the lip 34 of the seal 14. The placement of the obstruction element 30 across the opening defined by the seal 14 permits air to be drawn through the holes 36 in the obstruction element 30 while also discouraging the fabric 22 from (substantially) entering the body 12 of the suction cup 28. As noted the obstruction element 30 prevents ingestion by the body 12 of the fabric 22 to a degree that creates a non-removable deformation 26. As should be apparent, the degree (or magnitude) of the deformation 26 will change depending upon specific properties of the fabric 22.

It is noted that the suction cup 28 may be made from any suitable material. The body 12, the connector 18, the seal 14, and the obstruction element 30 may be constructed from the same material or from different materials. For example, it is contemplated that the body 12 and the connector 18 will be made from a metal material, such as aluminum or an alloy of aluminum. Aluminum is anticipated to be employed because of its strength and low weight. As noted above, the suction cup 28 is contemplated to be employed together with a plurality of other suction cups 28. The plurality of suction cups is contemplated to be mounted on a suitable robot so that the fabric 22 may be transferred from one area to a predetermined position on a mold. For this reason, light-weight materials are contemplated to be preferred materials for the components of the suction cup 28.

Alternatively, one or more of the components of the suction cup 28 may be made from plastic materials such as polyvinyl chloride (“PVC”), polytetrafluoroethylene (“PTFE”), or the like. As should be apparent to those skilled in the art, any other plastic material, thermoplastic material, elastomeric material, rubber, or polymeric material may be employed without departing from the scope of the present invention.

It is also contemplated that the suction cup 28 may be made from a number of different materials. For example, the body 12 and connector 18 may be made from a metal such as aluminum. The annular section 14, however, may be made from a plastic or thermoplastic material, among other suitable candidates, as noted above. The obstruction element 30 may be made from metal or from a plastic material, for example.

So as not to be limiting of the present invention, it is contemplated that one or more of the components of the suction cup 28 may be made from a ceramic material or a composite material. As should be apparent to those skilled in the art, the exact material employed for the components of the suction cup 28 are not critical to the operation of the suction cup 28. The listing of particular materials for any of the components of the suction cup 28 (or any other embodiment described herein), therefore, is meant to be exemplary of the types of materials that may be employed and is not meant to be limiting of the present invention.

While the particular material selected for the various components of the suction cup 28 is not critical to operation of the suction cup 28, it is contemplated that the flanged section 14 (or seal 14) may be made from a flexible material so that the suction cup 28 properly forms a seal around the uneven surface of the mold. Among other possible options, plastics, thermoplastic materials, rubbers, and elastomeric materials are suitable candidates for the construction of the flanged section 14.

With respect to the obstruction element 30, it is contemplated that the obstruction element 30 will be made from a metal material. Aluminum, steel, and brass are contemplated as possible metals for the obstruction element 30. As should be apparent, however, any suitable material may be employed without departing from the scope of the present invention. Alternatively, the obstruction element 30 may be made from flexible, rigid, or semi-rigid materials such as plastic, thermoplastic materials, rubbers, elastomeric materials, or polymeric materials (among others) without departing from the scope of the present invention.

As indicated in FIG. 2, the obstruction element 30 is contemplated to be a structure that is separate from the seal 14. If so constructed, the obstruction element 30 is contemplated to connect to the seal 14 via any suitable fastener, including an adhesive fastener. Moreover, the seal 14 may include one or more fingers or protrusions that are designed to grab onto the obstruction element 30 and retain the obstruction element 30 thereagainst.

In a variation of the embodiment illustrated in FIG. 2, it is also contemplated that the obstruction element 30 may be integrally formed with the body 12 without departing from the scope of the present invention.

As noted above, one embodiment of the suction cup 28 of the present invention contemplates that the seal 14 will have some flexibility and/or resiliency. As such, it is contemplated that the seal 14 is likely to be made from a flexible plastic, rubber, or other suitable material. If the seal 14 is flexible and the suction cup 28 is pressed, either intentionally or accidentally, against a mold or one or more previously laid layers of fabric 22, it is preferred that the suction cup 28 present at least a modest amount of pliability. Specifically, if the seal 14 is flexible, the seal 14 will minimize any potential damage that may be done to the mold, the fabric 22, or any layers of fabric 22 previously deposited onto the mold. Moreover, a flexible seal 14 also helps to prevent or at least discourage any damage to the suction cup 28.

As noted above, and as illustrated in FIG. 2, the obstruction element 30 is recessed in the seal 14 by a distance 32. The distance 32 permits at least a portion of the annular seal 14 to extend outwardly with respect to a plane defined by the obstruction element 30. If the seal 14 is flexible, as noted above, the lip 34 will be afforded at least some degree of flexion without distorting or damaging the obstruction element 30, should the suction cup 28 press against the mold.

With respect to the obstruction element 30, it is noted that the obstruction element 30 may present any suitable design without departing from the scope of the present invention. It is contemplated, for example, that the obstruction element 30 will simply be made from a wire mesh. In an alternative embodiment, the obstruction element 30 may be a perforated plate, breathable fabric, or other suitable alternative. Whether constructed as a perforated plate or a mesh, the obstruction element 30 is contemplated to include a plurality of holes 36 that are machined into the obstruction element 30 in a predetermined pattern for optimum air flow. It is noted that the size, shape, and distribution pattern of the holes 36 will be such that the obstruction element prevents distortion of the fabric 22 beyond an acceptable level, as indicated above.

Where the obstruction element 30 is made from a wire mesh, the holes 36 will be essentially square or rectangular. The holes 36, however, may have any suitable shape without departing from the scope of the present invention. For example, the holes 36 may be drilled through a plate or other suitable substrate, as discussed. In still another example, the holes 36 may be arcuate oblong passages that are disposed around a focal point on the obstruction element 30. As should be apparent, there are limitless variations on the structures that define the holes 36 in the obstruction element 30. The present invention is not considered to be limited to any particular pattern, shape, and size of the holes 36 in the obstruction element 30.

With continued reference to FIG. 2, it is noted that the recessed positioning of the obstruction element 30 in the seal 14 is likely to result in the creation of a slight distortion region 38. This distortion region 38, however, is limited in its height by the distance 32. As a result, while the suction cup 28 may create a slight distortion 38 in the fabric 22, the distortion is modest. Due to the modest height 32 of the distortion 38, the distortion 38 exists only temporarily. Upon release from the suction cup 28, the fabric 22 is anticipated to return to a flat state (i.e., an acceptably distorted state), thereby avoiding the creation of protrusions 26 that are not easily removed from the fabric 22. In other words, the distance 32 is such that the resiliency of the fabric 22 itself eliminates the slight distortion 38 after the fabric 22 is released from the suction cup 28.

As noted above, and as now clarified, the suction cup 28 (along with the other embodiments described herein) is not anticipated to eliminate any and all distortion of the fabric 22. To the contrary, as indicated above, there is an acceptable amount of distortion of the fabric 22 that is permitted. Specifically, the present invention permits a degree of distortion in the fabric 22 that is correctible. As noted, an acceptable level of distortion is such that the fabric 22 may be returned to a flat state (or a substantially flat state) after being released from the suction cup(s) 28. A correctible distortion 26 is one that is not permanently introduced into the fabric 22. Non-permanent distortions of the fabric include, but are not limited to, those distortions that are self-correcting and/or those that may be smoothed out by a device or person after the fabric 22 has been released from the suction cup 10.

As should be apparent from the foregoing, by including an obstruction element 30, it is possible to apply a higher magnitude of suction to the suction cup 28 than would be prudent for the suction cup 10. Specifically, the presence of the obstruction element 30 prevents the higher magnitude of the suction from establishing a distortion 26 in the fabric 22 that is unacceptable from a quality point of view.

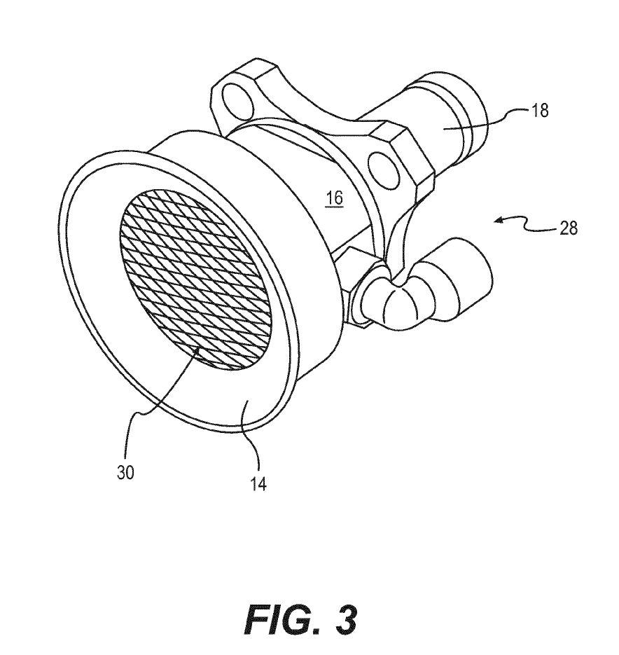

FIG. 3 is a perspective illustration of one embodiment of the suction cup 28 that is discussed in connection with FIG. 2. In this illustration, the obstruction element 30 that has been selected for the suction cup 28 is a metal mesh, as discussed above. The obstruction element 30 is recessed from the lip 34 by the distance 32, as discussed in connection with FIG. 2.

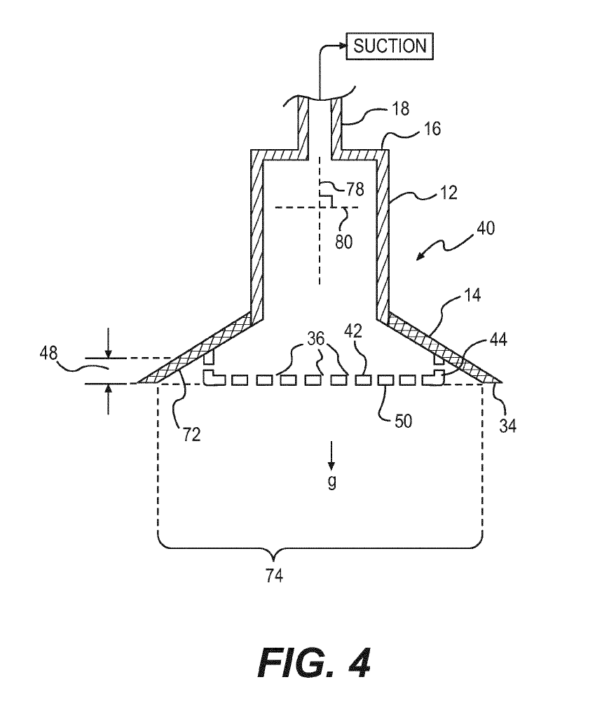

FIG. 4 is a cross-sectional side view of a second embodiment of a suction cup 40 according to the present invention. In this embodiment, the suction cup 40 includes an obstruction element 42 that is not planar in shape. Instead, the obstruction element 42 includes side walls 44 that extend from the inner surface 46 of the suction cup 40. Specifically, the walls 44 have a height 48.

As with the embodiment described in connection with FIGS. 2 and 3, it is contemplated that the obstruction element 42 will be made from a wire mesh material. However, as noted, a wire mesh for the obstruction element 42 is not required to practice the present invention.

As illustrated in FIG. 4, the height 48 of the obstruction element 42 positions the exterior surface 50 of the obstruction element 42 at the same level as the lip 34 of the annular section 14. In other words, in this embodiment, when suction is applied to the fabric 22, the fabric 22 cannot be drawn into the suction cup 40. As noted above, this means that the fabric 22 cannot be drawn into the suction cup 40 to a degree greater than is considered acceptable for the particular fabric 22. As a result, as before, this embodiment presents a construction that creates little if any distortion of the fabric 22. Alternatively, where the embodiment does result in a distortion of the fabric 22, any such distortion is within acceptable tolerances.

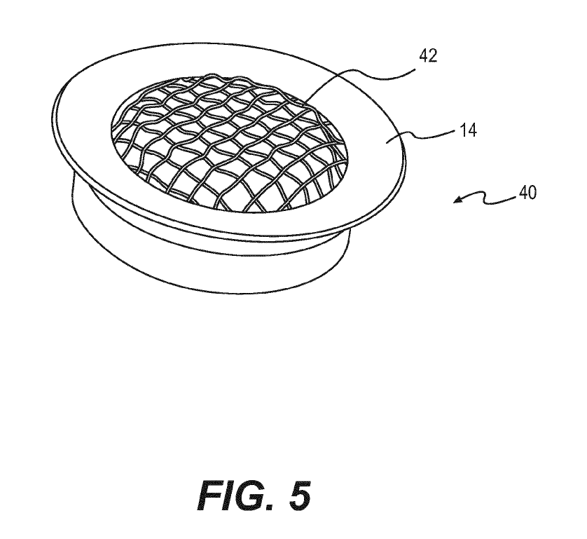

FIG. 5 is a perspective illustration of one contemplated embodiment of the seal 14 and the obstruction element 42 illustrated in FIG. 4. The protruding shape of the grate 42 is evident in this illustration.

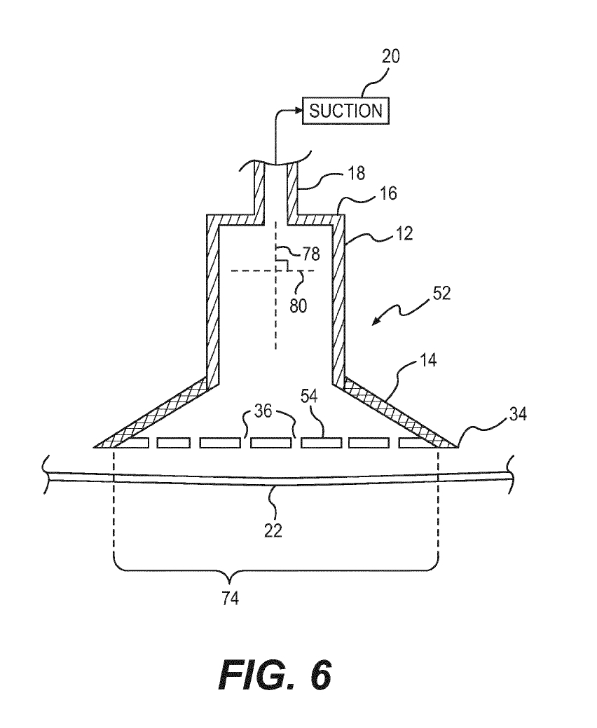

FIG. 6 is a cross-sectional side view of a third embodiment of a suction cup 52 according to the present invention. In this embodiment, the obstruction element 54 is flush with the lip of the annular section 14. As should be apparent, therefore, consistent with the prior embodiment, there is little likelihood of distortion of the fabric 22 greater than an acceptable amount, as discussed above. As in prior examples, the obstruction element 54 is contemplated to be a wire mesh, but suitable equivalents may be employed without departing from the scope of the present invention.

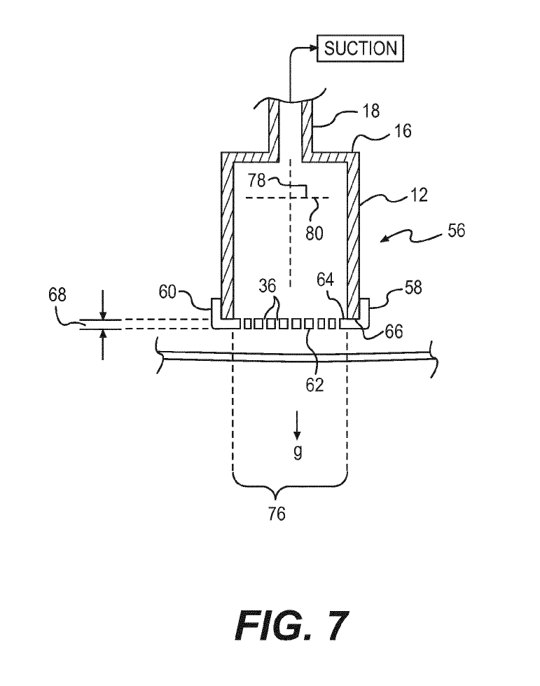

FIG. 7 illustrates a fourth embodiment of a suction cup 56 according to the present invention. Here, the seal 14 has been omitted. In its place, a cap 58 covers the end of the body 12.

The cap 58 (also referred to herein as an obstruction element 58) includes side walls 60 that engage the side walls of the body 12. The end 62 of the obstruction element 58 includes a plurality of holes 36, as previously described. An interior surface 64 of the cap 58 engages a lip 66 of the body 12.

As should be apparent from FIG. 7, the cap 58 presents an exterior surface 62 that is disposed a short distance 68 below the lip 66 of the body 12. The exterior surface 62 of the cap 58, therefore, establishes a surface that contacts the fabric 22. As noted above, the obstruction element 58 minimizes any distortion of the fabric 22 to an amount greater than acceptable for the fabric 22.

As noted above, a Coanda gripper device is contemplated as one device for generation of the suction for the suction cup 28, 40, 52, 56. As also noted, any other means for generating suction may be employed without departing from the scope of the present invention.

With respect to all four of the embodiments of the suction cup 28, 40, 52, 56, the obstruction elements 30, 42, 54, 58 are disposed such that the obstruction elements 30, 42, 54, 58 are substantially flush with the lips 34, 66 of the respective bodies 12 thereof so as to control the formation of distortions 26 in the fabric 22 to an acceptable amount. In addition, the obstruction elements 30, 42, 54, 58 are attached either to the annular section 14 or to the body 12 of the suction cups 28, 40, 52, 56.

It is noted that the suction cups 28, 40, 52, 56 are each illustrated as being circular in cross-section. As should be apparent to those skilled in the art, the shapes of the obstruction elements 30, 42, 54, 58 need not be circular to practice the present invention. Any suitable shape may be employed without departing from the scope of the present invention. For example, the obstruction elements 30, 42, 54, 58 may have cross-sections that are square, rectangular, polygonal, elliptical, or amorphously (i.e., irregularly) shaped without departing from the scope of the present invention. Where other than circular shape is employed, the seal 14 will appear as a flanged section. At least for this reason, the seal 14 also is understood to function as a flanged section or element 14 so as not to limit the scope of the present invention.

Returning to the embodiments described and illustrated, it is noted that, in the first embodiment, the exterior surface 70 of the obstruction element 30 is positioned slightly inwardly from the lip 34 of the suction cup 28. In the second embodiment, the obstruction element 42 extends from an interior surface 72 of the seal 14 so that an exterior surface 50 is flush with the lip 34 of the seal 14. In the third embodiment, the obstruction element 54 is disposed in the annular section 14 such that the perforated plate 54 is flush with the lip 34 of the flanged section 34. In the fourth embodiment, the exterior surface of the obstruction element 58 is disposed a distance 68 exterior to the lip 66 of the suction cup 56.

In view of the embodiments described and illustrated, therefore, the present invention is intended to encompass constructions where the obstruction element 30, 42, 54, 58 is disposed slightly inward from the lip 34, flush with the lip 34, or slightly outward from the lip 66 of the structure forming the body 12 of the suction cup 28, 40, 52, 56. As noted, in each example, the position of the obstruction element 30, 42, 54, 58 is substantially flush with the lip 34, 66 such that distortion 26 of the fabric 22 is minimized, eliminated, or controlled to a predetermined amount within acceptable tolerances.

As should also be apparent from the discussion of the embodiments of the suction cup 28, 40, 52, 56, the obstruction elements 30, 42, 54, 58 need not exactly cover the area of the opening 74, 76 defined thereby. This construction is evident in the first, second, and fourth embodiments of the suction cups 28, 40, 52, 56. With respect to the suction cups 28, 40, 52 the obstruction elements 30, 42, 54 are slightly smaller than the opening 74, 76 that they cover. In the case of the suction cup 56, the perforated plate 58 is actually slightly larger than the opening 76, due to the fact that the obstruction element 58 engages the exterior walls of the body 12.

In each of the embodiments, the suction cups 28, 40, 52, 56 each define a central axis 78 that is normal to a plane 80. In each of the embodiments, the obstruction elements 30, 42, 54, 58 are parallel to the plane 80 and, therefore, perpendicular to the central axes 78. This construction is not required to practice the present invention. It is contemplated that the obstruction elements 30, 42, 54, 58 may be disposed at an angle to the plane 80 without departing from the scope of the present invention.

While the present invention has been described in connection with suction cups that are intended to be employed in connection with a device capable of moving sheets of composite fiber fabrics from one location to another, the present invention should not be considered as being limited solely to such use. The present invention may be employed in other contexts without departing from the scope of the present invention.

As noted above, the present invention is described in connection with one or more embodiments thereof. The embodiments are intended to be illustrative of the breadth of the present invention. Focus on any one particular embodiment is not intended to be limiting thereof. The present invention, therefore, is intended to encompass variations and equivalents, as would be appreciated by those skilled in the art.

1. A suction cup for handling fabric, the suction cup comprising:
a body having a first end having an opening and a second end adapted to be connected to a vacuum source, thereby drawing a vacuum through the opening;
a lip on the body, defining a periphery around the opening;
an obstruction element positioned in communication with the body of the suction cup, the obstruction element defining a plurality of holes therethrough,
wherein the obstruction element discourages distortion of the fabric when drawn to the suction cup to a degree that exceeds a predetermined, acceptable threshold.

2. The suction cup of claim 1, wherein the body further comprises a seal extending outwardly from the first end adjacent to the lip, the seal defining the opening.

3. The suction cup of claim 2, wherein the obstruction element extends across at least a portion of the opening defined by the seal.

4. The suction cup of claim 1, wherein the obstruction element comprises a wire mesh.

5. The suction cup of claim 1, wherein the obstruction element comprises at least one material selected from a group comprising a metal, a metal alloy, plastic, a thermoplastic material, rubber, an elastomeric material, polyvinyl chloride, polytetrafluoroethylene, a composite material, and a ceramic.

6. The suction cup of claim 2, wherein the seal comprises a flexible material.

7. The suction cup of claim 6, wherein the seal comprises at least one material selected from a group comprising plastic, a thermoplastic material, rubber, and an elastomeric material.

8. The suction cup of claim 1, wherein the body comprises at least one material selected from a group comprising a metal, a metal alloy, plastic, a thermoplastic material, rubber, an elastomeric material, polyvinyl chloride, polytetrafluoroethylene, a composite material, and a ceramic.

9. The suction cup of claim 1, wherein the exterior surface of the obstruction element is disposed interiorly to the lip.

10. The suction cup of claim 1, wherein the exterior surface of the obstruction element is flush with the lip.

11. The suction cup of claim 1, wherein the plurality of holes are arranged in a predetermined pattern.

12. The suction cup of claim 4, wherein the plurality of holes are defined by wires forming the wire mesh.

13. The suction cup of claim 1, wherein the predetermined, acceptable threshold for distortion of the fabric is less than a permanent distortion of the fabric.

14. The suction cup of claim 13, wherein the fabric is a woven fabric.

15. The suction cup of claim 13, wherein the fabric is a non-woven fabric.

16. The suction cup of claim 13, wherein the fabric comprises a composite material.

17. The suction cup of claim 16, wherein the composite material comprises carbon fiber.

18. The suction cup of claim 16, wherein the composite material comprises an aramid compound.

19. The suction cup of claim 16, wherein the composite material further comprises a resin.

20. The suction cup of claim 1, wherein the vacuum source generates suction via a Coanda gripper.

21. A machine for handling fabric material that comprises at least one suction cup of claim 1.
